(19) United States
(12) Patent Application Publication
(10) Pub. No.: US 2026/0110388 A1
(43) Pub. Date: Apr. 23, 2026

(54) ANTI-CORROSION TAPE COMPRISING AT LEAST ONE WOVEN FABRIC

(71) Applicant: DENSO-HOLDING GMBH & CO., Leverkusen (DE)

(72) Inventor: Thomas Markus KAISER, Inden (DE)

(21) Appl. No.: 19/152,297

(22) PCT Filed: Feb. 2, 2024
(86) PCT No.: PCT/EP2024/052600

§ 371 Date: Jul. 30, 2025

(30) Foreign Application Priority Data
Feb. 2, 2023 (DE) 10 2023 102 631.3

(51) Int. Cl. F16L 58/16; C09J 7/38; C09J 11/08; C23F 15/00; D03D 3/00

(52) U.S. Cl. CPC F16L 58/16; C09J 7/383; C09J 11/08; C23F 15/00; D03D 3/005; D10B 2401/062; D10B 2401/063; D10B 2505/00

(57) ABSTRACT

The present invention relates to an anti-corrosion tape, in particular for producing a pipe covering, comprising at least one bonding ply, produced from a material selected from the group including at least one butyl rubber and/or at least one polyisobutylene, at least one bidirectional woven fabric being at least partially embedded in the at least one bonding ply.

### CROSS REFERENCE TO RELATED APPLICATIONS

This application is a national-stage application under 35 U.S.C. § 371 of International Application No. PCT/EP2024/052600, filed Feb. 2, 2024, which International Application claims benefit of priority to German Patent Application No. 102023102631.3, filed Feb. 2, 2023.

### TECHNICAL FIELD

The present invention relates to an anti-corrosion tape, in particular for producing a pipe covering, a method for its production, its use and a method for achieving corrosion protection on pipes and installations comprising pipes.

### BACKGROUND

Anti-corrosion compositions and anti-corrosion systems, for example for pipe systems such as pipelines, but also for other technical systems, are known in many forms from the prior art.

Two-layer tapes are known from the prior art to protect tubular objects from corrosion. Such anti-corrosion tapes are wrapped around the pipe in such a way that an overlapping area is created in order to achieve a continuous, tight covering of the tubular object. Particularly in the area of the overlap, there is the problem that a leak can form due to insufficient contact between the upper side of the tape of the previous winding and the lower side of the tape of the subsequent winding, allowing water to enter. The water can cause corrosion along the overlap area, which is known as spiral corrosion. This is favoured by voids formed in the winding adjacent to a tape edge of a previous winding, which are formed by the tape of the subsequent winding covering the tape edge of the previous winding. There are also comparable corrosion problems with the formation of voids when welding beads are overwound with anti-corrosion tapes, which are used to join pipes together or are applied when pipes are repaired. When tapes are applied, wrinkles can also form so that an adequate sealing effect is not achieved. Wrinkles in the winding of an anti-corrosion tape offer points of attack for forces acting during handling and operation of the pipeline, for example from the soil, and can be the cause of detachment and leaks. In this case, the effectiveness of corrosion-inhibiting tapes is also limited.

There is a need to minimise leaks and empty spaces in the overlap area, in particular to prevent spiral corrosion, and to reduce creases.

US 2022/214005 A1 discloses an anti-corrosion coating for a metal pipe. The coating has an inner sheath with glass fibers which carries a viscoelastic thermoplastic corrosion protection material. RO 118 806 B1 discloses a self-adhesive tape for the corrosion and electrical protection of buried metal pipes, comprising a non-corrosive protective film to which a permanent adhesive is applied. The protective film can be doubled with a carrier for mechanical protection and sun protection. DE 20 32 007 A1 discloses an anti-corrosion protective tape consisting of a flexible carrier which is provided on both surfaces with a substance which is a mixture of an oxidized bitumen and a flowable bituminous oil and preferably additionally a powder portion and a fungicide. US 2011/079311 A1 discloses a protective seal comprising a first wrap comprising a corrosion resistant material wrapped around a sealing area that contacts the outer surface of a pipe assembly. A second wrap, which is made of a self-adhering fiberglass composite, wraps around the first wrap. DE 10 2018 1 07257 B3 discloses a device for an improved wrapping comprising a base frame, a drive unit, a linear drive and a winding unit for unwinding at least one flat product for producing the wrapping. WO 2014/157522 A1 discloses a method wherein an anti-corrosion film is produced by applying an oil paste containing oil and wax to a base material film.

### SUMMARY

It is therefore the object of the present invention to provide an improved anti-corrosion tape with which the formation of creases and the formation of cavities in the overlap area can be reduced or even avoided.

### DETAILED DESCRIPTION

This object is achieved by an anti-corrosion tape, in particular for producing a pipe covering, comprising at least one bonding ply, produced from a material comprising at least one butyl rubber and/or at least one polyisobutylene, wherein at least one bidirectional woven fabric is at least partially embedded in the at least one bonding ply, whereby the at least one bidirectional woven fabric has a ratio of a bending stiffness according to the beam method according to DIN 53121:2014-08 in the transverse direction to the longitudinal direction in a range between 1:1.1 and about 1:8.

If the term “approximately” is used in the context of the invention in connection with values or value ranges, this is to be understood as a tolerance range that the person skilled in the art considers to be customary in this field. In particular, a tolerance range of ±20%, preferably ±10% and more preferably ±5% is intended. Insofar as different ranges for specifications and/or for definitions are indicated in the present invention, the lower limits and the upper limits of the different ranges can be combined with one another with respect to the respective specification and/or to the respective definition.

According to the invention, the anti-corrosion tape comprises at least one bonding ply. According to the invention, the at least one bonding ply is produced from a material comprising at least one butyl rubber and/or at least one polyisobutylene. Preferably, the bonding ply comprises a material selected from a group comprising at least a first, preferably depolymerised, butyl rubber having an apparent Brookfield viscosity at 66° C. in accordance with DIN EN ISO 2555:2000-01 in a range from about 400,000 mPa·s to about 2,000,000 mPa·s, and an average molecular weight M_{w} (also called the average molar mass or molecular mass) in a range from about 20.000 to about 60,000 and/or at least one first polyisobutylene with an average relative molar mass Mᵥ in a range from about 14,000 g/mol, preferably from about 30,000 g/mol, to about 150,000 g/mol, preferably up to about 100,000 g/mol, and a Staudinger index J₀ in a range from about 15 cm^{3/}g to about 70 cm^{3/}g, and at least one second butyl rubber and/or at least one second polyisobutylene. The at least one second, preferably at least partially cross-linked, butyl rubber preferably has a Mooney viscosity ML(1+3) at 127° C. in a range from about 65 MU to about 100 MU in accordance with ISO 289:2005. The at least one second polyisobutylene preferably has a Staudinger index J₀ in a range from about 75 cm^{3/}g to about 235 cm^{3/}g and with an average relative molar mass My in a range from about 150,000 g/mol, preferably from about 160,000 g/mol, to about 950,000 g/mol, preferably up to about 850,000 g/mol. More preferably, the material of the at least one bonding ply comprises a third butyl rubber and/or a third polyisobutylene. The at least one third, preferably solid, butyl rubber preferably has an average molar mass Mᵥ in a range from about 150,000 to about 2,000,000 and a Mooney viscosity ML (1+8) at 125° C. in a range from about 20 MU to about 62 MU, measured in accordance with ISO 289:2005. The at least one third polyisobutylene preferably has an average relative molar mass My in a range from about 900,000 g/mol, preferably from about 950,000 g/mol, to about 7,500,000 g/mol, preferably up to about 6,500,000 g/mol, and a Staudinger index J₀ in a range from about 240 cm^{3/}g to about 900 cm^{3/}g. Preferably, the at least one bonding ply comprises a material selected from a group comprising at least a first polyisobutylene and/or a first butyl rubber and at least a second polyisobutylene and/or a second butyl rubber. More preferably, the bonding ply comprises a material selected from a group comprising at least a first polyisobutylene and/or a first butyl rubber, at least a second polyisobutylene and/or a second butyl rubber, and at least a third polyisobutylene and/or a third butyl rubber. Particularly preferably, the at least one bonding ply comprises at least one first or at least one second polyisobutylene as well as at least one first or at least one second butyl rubber. Even more preferably, the at least one bonding ply comprises a first, a second and optionally a third butyl rubber, and no polyisobutylene. Even more preferably, the at least one bonding ply comprises a first, a second and optionally a third polyisobutylene, and no butyl rubber. Alternatively, the bonding ply comprises only a second butyl rubber or only a second polyisobutylene. In a further alternative configuration, the bonding ply comprises only a third butyl rubber or only a third polyisobutylene. In a further alternative configuration the at least one bonding ply comprises a material selected from a group comprising at least a second polyisobutylene and/or a second butyl rubber and at least a third polyisobutylene and/or a third butyl rubber, preferably a second polyisobutylene and a third butyl rubber or a third polyisobutylene and a second butyl rubber. However, the bonding ply may also comprise a second and a third polyisobutylene or a second and a third butyl rubber.

The Staudinger index J₀ was previously also referred to as intrinsic viscosity. It is calculated from the flow time at 20° C. through a capillary of an Ubbelohde viscometer in accordance with the following formula (Schulz-Blaschke equation):

$${J}_{0} = {η}_{sp} / c ( 1 + 0.31 * {η}_{sp} ) {cm}^{3} / g$$

$$wherein$$

$${η}_{sp} = \frac{t}{{t}_{0}} - 1 ( specific viscocity ) ,$$

wherein t is the flow time of the solution with a Hagenbach-Couette correction, t₀ is the flow time of the isooctane solvent with Hagenbach-Couette correction and c is the concentration of the solution in g/cm^{3.} The average relative molar mass Mᵥ (viscosity average) is calculated from the following formula:

$$\sqrt[0.65]{\frac{{J}_{0} \times {10}^{2}}{3.06}}$$

Polyisobutylenes within the meaning of the present invention are preferably synthesised via a cationic polymerisation of isobutene (2-methylpropene) in a temperature range between about −100° C. and about 0° C. The temperature influences the molar mass of the polyisobutylene produced in this way, the lower the temperature, the higher the molar mass of the same. Usually boron trifluoride or aluminium trichloride in aqueous or alcoholic solution are used as initiators.

The at least one first polyisobutylene advantageously has a Staudinger index J₀ in a range from about 22 cm³/g to about 65 cm³/g, and even more preferably a Staudinger index Jo in a range from about 25 cm³/g to about 45 cm³/g. Preferably, the at least one first polyisobutylene has an average relative molar mass Mᵥ (viscosity average) in a range from about 24,000 g/mol, preferably from about 35,000 g/mol, to about 130,000 g/mol, preferably up to about 95,000 g/mol, and more preferably an average relative molar mass Mᵥ in a range from about 30,000 g/mol, preferably from about 37,000 g/mol, to about 75,000 g/mol, preferably up to about 70,000 g/mol. The at least one first polyisobutylene is advantageously comprised in an amount in a range from about 28% by weight to about 60% by weight, more preferably in an amount in a range from about 33% by weight to about 50% by weight, in each case based on the total amount of the at least one bonding ply.

The at least one second polyisobutylene preferably has a Staudinger index J₀ in a range from about 106 cm³/g to about 160 cm³/g. Preferably, the at least one second polyisobutylene has an average relative molar mass Mᵥ in a range from about 250,000 g/mol to about 600,000 g/mol, preferably up to about 550,000 g/mol. Preferably, the at least one second polyisobutylene is comprised in an amount in a range from about 10% by weight to about 35% by weight, more preferably in an amount in a range from about 13% by weight to about 28% by weight, in each case based on the total amount of the at least one bonding ply.

The at least one third polyisobutylene preferably has a Staudinger index Jo in a range from about 400 cm³/g to about 800 cm³/g, and even more preferably a Staudinger index J₀ in a range from about 500 cm³/g to about 700 cm³/g. Preferably, the at least one third polyisobutylene has an average relative molar mass Mᵥ in a range from about 1,500,000 g/mol, preferably from about 2,000,000 g/mol, to about 6,000,000 g/mol, preferably up to about 5,000,000 g/mol, more preferably in a range from about 3,000,000 g/mol to about 5,000,000 g/mol, preferably up to about 4,800,000 g/mol. The at least one third polyisobutylene is advantageously comprised in an amount in a range from about 1% by weight to about 20% by weight, more preferably in an amount in a range from about 2% by weight to about 10% by weight, still more preferably in an amount in a range from about 3% by weight to about 8% by weight, in each case based on the total amount of the at least one bonding ply.

The ratio of the at least one first polyisobutylene, that is to say, the total amount of the first polyisobutylene used, even if a mixture is present, to the at least one second polyisobutylene, that is to say, the total amount of the second polyisobutylene, even if this is present in a mixture, is advantageously in a range from about 2.5:1 to about 1:2.5, more preferably in a range from about 2.2:1 to about 1:1.

The polyisobutylenes used, that is to say, both the first, the second and the third polyisobutylene, advantageously have a glass transition temperature Tg (measured calorimetrically by DSC) of less than −50° C., more preferably less than −58° C. Particularly preferably, the glass transition temperature of the at least one first, the at least one second and the at least one third polyisobutylene is in a range from about−55° C. to about −68° C., more preferably in a range from about −58° C. to about −66° C. The higher molar mass, at least one second polyisobutylene can thus still be addressed as a highly viscous liquid and has a certain tendency to creep.

In the context of the present invention, the term butyl rubber is understood in particular to mean co-or block co-polymers of isobutene with about 0.5% by weight to about 5% by weight of isoprene, based on the total amount of butyl rubber; these are produced in particular by cationic polymerisation. A cross-linking reaction can be initiated via the isoprene used and the carbon-carbon double bonds present therein, which act as functional groups. In the context of the present invention, the term butyl rubber also includes, in particular, halogenated butyl rubbers, especially those which are chlorinated or brominated (chlorobutyl rubber or bromobutyl rubber). Mixtures of a plurality of butyl rubbers can also be used, that is to say, more than at least one butyl rubber.

The at least one first, preferably depolymerised, butyl rubber is preferably obtained by depolymerisation of butyl rubbers (IIR). The at least one first butyl rubber has a low molecular weight. It is particularly preferably present in liquid form at 23° C. In contrast, the at least one third butyl rubber is not depolymerised and has a high molecular weight compared to the first butyl rubber. The at least one third butyl rubber is preferably present in solid form at 23° C.

The at least one first, preferably depolymerised, butyl rubber preferably has an apparent Brookfield viscosity in accordance with DIN EN ISO 2555:2000-01 at 66° C. in a range from about 600,000 mPa · s to about 1,600,000 mPa·s, more preferably in a range from about 700,000 mPa · s to about 1,500,000 mPa·s. Preferably, the at least one first, preferably depolymerised, butyl rubber has an average molecular weight M_{w} in a range from about 20,000 to about 60,000. The at least one first, preferably depolymerised, butyl rubber advantageously has the property of undergoing a cross-linking reaction even at low temperatures, in particular at room temperatures of, for example, 20° C. or 23° C., or even at slightly elevated temperatures of, for example, 40° C. to 50° C., due to the unsaturated carbon- carbon double bonds present therein. Preferably, the first butyl rubber is comprised by the bonding ply in an amount in a range from about 20% by weight to about 66% by weight, preferably in an amount in a range from about 28% by weight to about 60% by weight, more preferably in an amount in a range from about 33% by weight to about 50% by weight, in each case based on the total amount of the at least one bonding ply.

The at least one second, at least partially cross-linked (hereinafter also referred to as partially pre-cross-linked) butyl rubber, which has a lower proportion of unsaturated bonds than conventional butyl rubbers, preferably has a Mooney viscosity ML(1+3) at 127° C. in a range from about 70 MU to about 93 MU, more preferably in a range from about 78 MU to about 91 MU, measured in accordance with ISO 289:2005 or in accordance with ASTM 1604-04. The specific density of the at least one second, partially cross-linked butyl rubber is advantageously in a range from about 0.5 to about 1.1 at a temperature of 25° C. in accordance with ASTM D1875 in the 2003 version, preferably in a range from about 0.9 to about 0.98. Particularly preferably, the second butyl rubber is comprised of the at least one bonding ply in an amount in a range from about 1% by weight to about 20% by weight, more preferably in an amount in a range from about 2% by weight to about 10% by weight, still more preferably in an amount in a range from about 3% by weight to about 8% by weight, in each case based on the total amount of the at least one bonding ply.

The at least one third butyl rubber advantageously has an average molecular weight M_{w} in a range from about 200,000 to about 1,800,000, more preferably in a range from about 250,000 to about 600,000. Preferably, the at least one third butyl rubber has a Mooney viscosity ML(1+8) at 125° C. in a range from about 30 MU to about 60 MU, more preferably in a range from about 40 MU to about 59 MU, still more preferably in a range from about 40 MU to about 55 MU, measured in accordance with ISO 289:2005. The at least one third butyl rubber is advantageously comprised of the at least one bonding ply in an amount in a range from about 10% by weight to about 50% by weight, more preferably in an amount in a range from about 35% by weight to about 46% by weight, and more preferably in an amount in a range from about 15% by weight to about 35% by weight, in each case based on the total amount of the at least one bonding ply.

Advantageously, the at least one third butyl rubber has unsaturation values in a range from about 1 mol % to about 3 mol %, more preferably in a range from about 1.3 mol % to about 2.5 mol %. This means that preferably about 1 mol % to about 3 mol %, more preferably about 1.3 mol % to about 2.5 mol % of unsaturated bonds, that is to say, carbon-carbon double bonds, are present as functional groups in the at least one third butyl rubber. Particularly preferably, the at least one third butyl rubber is produced by a co-polymerisation of isobutene and isoprene in methyl chloride as solvent. The unsaturation (the degree of unsaturation) of the at least one third butyl rubber may also be about 1.5 mol-%, in particular about 1.5±0.5 mol-%. The at least one bonding ply advantageously comprises the third butyl rubber, and preferably no further butyl rubber and no polyisobutylene, since with regard to the embedding of the at least one bidirectional woven fabric it can easily fill the recesses or free or empty spaces present in the woven fabric due to its flowability.

The material used for the bonding ply comprising at least one butyl rubber and/or at least one polyisobutylene, preferably at least one butyl rubber and no polyisobutylene, further preferably exactly one butyl rubber and no polyisobutylene, is selected in respect of the at least one bidirectional woven fabric in such a way that it enables the latter to be embedded. Further preferably, the material of the at least one bonding ply is adjusted in such a way that it is able to penetrate into the recess and empty spaces of the woven fabric under the action of pressure when brought together in the form, in particular, of an application on an outer side of the bidirectional woven fabric and to form a layer on the outer side of the woven fabric opposite the application after passing through the woven fabric, which layer has a sufficient adhesive strength. The anti-corrosion tape obtained in this way is able to produce a good bond to an object to be protected against corrosion, in particular in the form of a pipe covering, or to an external surface of the preceding winding to achieve full-surface adhesion. Furthermore, the material used is selected in such a way that it at least partially embeds the at least one bidirectional woven fabric even under tension when an anti- corrosion tape is applied as well as after application and at least partially prevents the material from being squeezed out of the woven fabric.

In addition to polyisobutylene and/or butyl rubber, the at least one bonding ply preferably comprises at least one filler material, at least one antioxidant, at least one cross-linking agent, at least one hydrocarbon resin, at least one process oil, at least one elastomer, preferably at least one polyethylene, and/or at least one stabilising agent. The other constituent parts mentioned can be added to the at least one bonding ply alone or in combination. Particularly preferably, the at least one bonding ply comprises at least one filler material. The at least one filler material is preferably comprised in an amount in a range from about 10% by weight, or about 20% by weight to about 70% by weight, more preferably in an amount in a range from about 30% by weight to about 65% by weight, still more preferably in an amount in a range from about 33% by weight to about 50% by weight, and still more preferably in an amount in a range from about 10% by weight to about 25% by weight, in each case based on the total amount of the at least one bonding ply. Particularly preferably, the at least one filler material is powdered or fibrous, more preferably it is powdered. In the context of the present invention, the term fibrous also includes such filling materials which have a needle-like structure. Particularly preferably, the at least one bonding ply comprises at least one first powdered filler material and at least one second fibrous filler material. In such a combined addition of at least one powdered and at least one fibrous filler material, it is particularly preferred that the fibrous filler material is added in an amount up to a maximum of that of the powdered filler material. A powdered as well as a fibrous filler material can be comprised in the at least one bonding ply in an amount in a range from about 10% by weight to about 40% by weight, preferably in an amount in a range from about 12% by weight to about 25% by weight, in each case based on the total amount of the at least one bonding ply.

Particularly preferably, the at least one bonding ply comprises a third butyl rubber, further preferably exclusively only at least one third butyl rubber, particularly preferably exactly one third butyl rubber and no first and/or second butyl rubber, and further preferably also no polyisobutylene. Particularly preferably, the at least one third butyl rubber has unsaturation values in a range from about 1.4 mol % to about 1.8 mol %. Particularly preferably, the at least one third butyl rubber has a Mooney viscosity ML (1+8) at 125° C. in a range from about 46 MU to about 56 MU, measured according to ISO 289:2005

Preferably, the anti-corrosion tape comprises a bidirectional woven fabric and a bonding ply made of a material selected from a group comprising at least one butyl rubber and/or at least one polyisobutylene, preferably comprising a third butyl rubber and no polyisobutylene, wherein the bidirectional woven fabric is at least partially embedded in the bonding ply. Preferably, the anti-corrosion tape comprises a bidirectional woven fabric, a peelable protective film and a bonding ply made of a material selected from a group comprising at least one butyl rubber and/or at least one polyisobutylene, wherein the bidirectional woven fabric is at least partially embedded in the bonding ply. Further preferably, the anti-corrosion tape consists of a bidirectional woven fabric, a peelable protective film and a bonding ply made of a material selected from a group comprising at least one butyl rubber and/or at least one polyisobutylene, wherein the bidirectional woven fabric is at least partially embedded in the bonding ply, and of a supplementary carrier film, in particular one which has adhesion-promoting layers on both outer sides, and optionally of a second bonding ply arranged on the outer side of the carrier film as seen from the woven fabric. The term “consists” in the sense of the present application means that the anti- corrosion tape does not comprise any other layer.

Preferably, the anti-corrosion tape comprises a protective film which can be peeled off, in particular when wrapping a pipe, pipeline or the like with the anti-corrosion tape according to the invention.

According to the invention, at least one bidirectional woven fabric is at least partially embedded in the at least one bonding ply. Preferably, the at least one bidirectional woven fabric comprises at least one weft yarn and at least one warp yarn. A bidirectional woven fabric is a woven fabric with different properties in the direction of the at least one weft yarn and in the direction of the at least one warp yarn. A warp yarn is those threads that are stretched lengthwise in a loom in the weaving mill. In the finished woven fabric, they lie parallel to the selvedge, while so-called weft yarns run transversely, i.e. substantially at right angles, to the warp yarn. In the production of a textile woven fabric, a weft yarn is the yarn that lies at right angles to the warp yarns stretched in the loom. Weft is the term for the yarn that is pushed back and forth over the warp to produce a woven fabric. Preferably, the at least one weft yarn lies in the transverse direction of the anti-corrosion tape. Preferably, the at least one warp yarn lies in the longitudinal direction of the anti-corrosion tape and is oriented substantially at right angles to the weft yarn. Preferably, the longitudinal direction of the anti-corrosion tape corresponds to the winding direction of the anti-corrosion tape on a pipe, a tank or a component of a tank. In order to reduce the empty spaces that can form when wrapping pipes with anti-corrosion tapes, including in the area of weld beads, the inventors have found that the at least one bidirectional woven fabric must have stiffer properties in the winding direction of the anti-corrosion tape on the one hand and more elastic properties on the other hand than is the case transversely to the winding direction. Bidirectional woven fabrics with warp threads with a higher bending stiffness as well as a higher elongation than the weft threads are therefore preferred. Due to the greater bending stiffness, elasticity and elongation of the woven fabric in the winding direction, the anti- corrosion tape wound around the pipe under tension exerts a greater force in the direction of the pipe to be wrapped, which, due to the softer properties of the woven fabric with a lower bending stiffness and thus of the anti-corrosion tape transverse to the winding direction, results in the anti-corrosion tape moulding itself more closely to the pipe, so that the empty spaces in overlapping areas or in weld beads can be reduced or even completely avoided. The anti-corrosion tape according to the invention can therefore advantageously mould itself well to the outer contours of pipes in particular and thus provide better protection against corrosion, but also prevent spiral corrosion in the overlap area.

Preferably, the at least one weft yarn and the at least one warp yarn comprise a material selected from a group comprising polypropylene, polyethylene, polyamides, aramid fibres, polyester or natural fibres or a combination of at least two of the aforementioned materials. Natural fibres are preferably selected from a group comprising jute, linen, cotton or hemp. Polyethylene is of low strength, hardness and rigidity, but has high extensibility and impact strength as well as low sliding friction. The properties of polypropylene are similar to polyethylene, but it is somewhat harder and more heat-resistant. Polypropylene has excellent resistance to fatigue. Polyamides are characterised by high strength, rigidity and toughness. Many of the properties of polyamides are largely dominated by the amide groups, which interact with each other via hydrogen bonds. Aramid fibres consist of aromatic polyamides, and in their chemical structure they have long chains of synthetic polyamides in which at least 85% of the amide groups (—CO—NH—) are directly linked to two aromatic groups. The molecular chains of the aramid fibres have a high orientation and crystallinity, which gives the fibre good mechanical properties such as tensile/tensile strength and good dimensional stability. The polyester family is a large group of materials, some of which have very different properties. Polyethylene terephthalate (PET) is particularly favoured. Due to their high tensile strength with low stretch and hardness, jute fibres are particularly suitable for the production of coarse, strong and resistant yarns. Linen fibres are stiff and tear-resistant. Due to its low elasticity, linen is susceptible to creasing, but its tear resistance makes it hard-wearing. Cotton is a natural fibre of plant origin with a chemical structure based on cellulose. Cotton has a high moisture absorption capacity. The breaking strength of hemp fibres is slightly higher than that of comparable flax fibres, and the tensile strength is around 350 N/mm². The elasticity, on the other hand, is only two to three percent and the flexibility depends on the bundle structure and the fineness of the fibres. In yarns, strength and flexibility are increased by spinning hemp and flax fibres together and thus utilising the properties of both fibres. The weft yarn is preferably made from polypropylene and the warp yarn from polyethylene, polypropylene or polyester, in particular from polyethylene terephthalate.

Preferably, the at least one woven fabric has a tensile strength according to DIN EN ISO 13934-1 in a transverse direction of the at least one bidirectional woven fabric in a range between about 200 N/5 cm and about 2500 N/5 cm, more preferably in a range between about 200 N/5 cm and about 1400 N/5 cm, further preferably in a range between about 250 N/5 cm and about 1200 N/5 cm, particularly preferably in a range between about 300 N/5 cm and about 1000 N/5 cm, and most preferably in a range between about 1600 N/5 cm and about 2400 N/5 cm. According to DIN EN ISO 139434-1, the width of each test sample must be 50 mm±0.5 mm (without edges) for the tensile strength measurement, and its length must be such that a measuring length of 200 mm is possible. Preferably, the at least one woven fabric has an elongation in the transverse direction according to DIN EN ISO 13934-1 in a range between about 2% and about 100%, more preferably in a range between about 10% and about 80%, particularly preferably in a range between about 20% and about 60%, and even more preferably in a range between about 10% and about 24%. Further preferably, the at least one woven fabric with a weft yarn made of jute has an elongation of about 2% in the transverse direction. Further preferably, the at least one woven fabric with a cotton weft yarn has an elongation of about 20% in the transverse direction. Preferably, the at least one woven fabric has an average bending stiffness according to the beam method according to DIN 53121:2014-08 in a transverse direction of the at least one bidirectional woven fabric in a range between about 0.1 N*mm and about 0.8 N*mm, further preferably in a range between 0.15 N*mm and about 0.75 N*mm, particularly preferably in a range between 0.18 N*mm and about 0.70 N*mm, and even more preferably in a range between 0.2 N*mm and about 0.50 N*mm. The measurement of the average bending stiffness according to the beam method according to DIN 53121:2014-08 was carried out in the present invention using samples with a sample width of about 30 mm, with a measuring length of about 10 mm, a maximum bending angle of about 7.5° and a deformation speed of about 0.02°/s. The at least one woven fabric exhibits sufficient conformability in the transverse direction, in particular with regard to the above value ranges for the average bending stiffness, and avoids the formation of cavities in the overlap area during the winding of the anti-corrosion tape according to the invention around a pipe, a pipeline or the like, or reduces the formation of these cavities or empty spaces, just as is the case with unevenness on a pipe, for example with weld beads.

Preferably, the weft yarn is ribbon-shaped. The weft yarn is further preferably fibrillated. Fibrillated weft yarn, in particular in the form of small ribbons, has a lower bending stiffness than non-fibrillated weft yarn. The weft yarn is preferably a twisted yarn. A twisted yarn is a yarn that consists of several yarns twisted together. A twisted yarn has a significantly higher tensile strength than non-twisted single yarns combined. Twisted yarns are mechanically resistant. The warp yarn is preferably a monofilament.

Preferably, the direction of twist of the weft yarn is Z or S. The yarn has a Z direction of twist if the fibres in the yarn run in the direction of the diagonal stroke of the letter Z when the yarn is held vertically. If it runs in the opposite direction, this is an S twist.

The weft yarn is preferably a core-spun yarn. Core-spun yarns have a two-part structure with a core and cover. The core preferably comprises polyethylene and the cover further preferably comprises polypropylene.

The weft yarn is preferably produced using a core spinning process. With a core spinning process, filaments can be covered with staple fibres during yarn production. A ring spinning machine is modified in such a way that a core can be produced together with a cover during twisting.

Preferably, the at least one weft yarn has a titre in a range from about 60 tex to about 140 tex, more preferably from about 70 tex to about 130 tex, particularly preferably from about 80 tex to about 120 tex. The titre is specified as weight per unit length. The derived unit “Tex” describes the yarn count of the yarn in grams/kilometre.

Preferably, the at least one woven fabric has a tensile strength according to DIN EN ISO 13934-1 in a longitudinal direction of the at least one bidirectional woven fabric in a range between about 400 N/5 cm and about 4000 N/5 cm, further in a range between about 190 N/5 cm and about 3000 N/5 cm, further preferably in a range between 300 N/5 cm and about 2800 N/5 cm, particularly preferably in a range between 500 N/5 cm and about 2500 N/5 cm, and very particularly preferably in a range between 1350 N/5 cm and about 2200 N/5 cm. Preferably, the at least one woven fabric has an elongation in the longitudinal direction according to DIN EN ISO 13934-1 in a range between about 2% and about 100%, further preferably between about 10% and about 80%, particularly preferably between about 20% and about 75%, and very particularly preferably between about 28% and about 70%, even more preferably up to about 60%. Preferably, the at least one woven fabric has an average bending stiffness according to the beam method according to DIN 53121:2014-08 in a longitudinal direction of the at least one bidirectional woven fabric in a range between about 0.2 N*mm and about 1.5 N*mm, further preferably in a range between 0.3 N*mm and about 1.4 N*mm, particularly preferably in a range between 0.4 N*mm and about 1.3 N*mm. On the one hand, the properties of the at least one warp yarn prevent wrinkling of the anti- corrosion tape when it is applied to a pipe. The tensile strength in the longitudinal direction of the at least one bidirectional woven fabric significantly influences the winding capability and final performance of the tape. The anti-corrosion tape with such a woven fabric fulfils the requirements of NACE SP0109-2019 (>192.5 N/cm according to ASTM D1000). The properties of at least one warp yarn and the woven fabric give the anti-corrosion tape strength and dimensional stability. Thanks to the strength and dimensional stability of the anti-corrosion tape in use, for example when the pipe moves and forces are transferred from the surrounding soil, wrinkling is avoided. Wrinkling can also be avoided during application of the anti-corrosion tape thanks to the strength and dimensional stability of the anti-corrosion tape. In addition, especially with regard to the specified weir ranges for the average bending stiffness in the longitudinal direction, which is preferably higher than the average bending stiffness in the transverse direction, it is ensured that a sufficient force is exerted on a pipe, for example, during winding under tension, so that the anti-corrosion tape can better mould itself to the pipe and follow its outer contour due to the lower average bending stiffness in the transverse direction and thus reduce or even avoid empty spaces or cavities.

Preferably, the at least one warp yarn has a titre in a range from about 20 tex to about 100 tex, more preferably from about 30 tex to about 90 tex, particularly preferably from about 40 tex to about 80 tex.

Preferably, the at least one bidirectional woven fabric has a tensile strength ratio in the transverse direction to the longitudinal direction in a range between about 2:1 and about 1:20, preferably in a range between about 1:1.1 and about 1:15, more preferably in a range between about 1:3 and about 1:12, particularly preferably in a range between about 1:5 and about 1:9, and even more preferably in a range between about 1.5:1 and about 1:2. Preferably, the at least one warp yarn has a higher tensile strength than the at least one weft yarn.

Preferably, the at least one bidirectional woven fabric has an elongation ratio in the transverse direction to the longitudinal direction in a range between about 0.5 and about 2, more preferably in a range between about 0.7 and about 1.8, particularly preferably in a range between about 0.9 and about 1.6, and even more preferably in a range between about 0.5 and about 1.6.

According to the invention, the at least one bidirectional woven fabric has a ratio of an average bending stiffness according to the beam method according to DIN 53121:2014-08 in the transverse direction to the longitudinal direction in a range between 1:1.1 and about 1:8, more preferably between about 1:1.3 and about 1:8, further preferably in a range between about 1:1.5 and about 1:6, particularly preferably in a range between about 1:1.7 and about 1:4. In the above-mentioned value ranges for the average bending stiffness, which is always higher in the longitudinal direction than in the transverse direction of the anti-corrosion tape, in relation to its winding direction, the latter exhibits excellent conformability to an outer contour of a surface, so that, just as in overlap areas when wrapping a tubular object, empty spaces or cavities are reduced or even avoided and thus the corrosion protection of the protected objects is improved.

Preferably, the at least one bidirectional woven fabric comprises between about 30 and about 90 weft yarns per 10 cm, more preferably between about 40 and about 80 weft yarns per 10 cm, particularly preferably between about 50 and about 70 weft yarns per 10 cm, and most preferably between about 50 and about 110 weft yarns per 10 cm, and even more preferably between about 60 and about 110 weft yarns per 10 cm. Preferably, the at least one bidirectional woven fabric comprises between about 120 and about 190 warp yarns per 10 cm, more preferably between about 130 and about 180 warp yarns per 10 cm, particularly preferably between about 140 and about 170 warp yarns per 10 cm, and even more preferably between about 145 and about 190 warp yarns per 10 cm. The number of yarns depends on the yarns used and their properties as well as on the pipes, pipelines and the like to be wrapped. If the warp yarn is very stiff, a lower number of yarns is required than if the warp yarn is less stiff. The number of yarns may also depend on the diameter of the pipe to be wrapped.

Preferably, the at least one bidirectional woven fabric has a thickness in a range between about 0.2 mm and about 2 mm, more preferably in a range between about 0.3 mm and about 2.8 mm, particularly preferably in a range between 0.5 mm and about 2.5 mm, and even more preferably in a range between about 0.5 mm and about 1 mm. Preferably, the at least one bidirectional woven fabric has a 1/1 plain weave.

According to the invention, at least one bidirectional woven fabric is at least partially embedded in the at least one bonding ply. For the purposes of the present application, embedded means incorporated, included or integrated into a larger whole. The at least one woven fabric is embedded in a bonding ply if the at least one woven fabric to be embedded is arranged within the bonding ply, i.e. is surrounded by material. Alternatively, the at least one woven fabric is partially embedded in a bonding ply in such a way that the at least one woven fabric is at least partially visible or exposed on one or both surfaces of the bonding ply. This is the case if the recesses or free spaces between the yarns in the woven fabric are substantially completely filled with the material of the bonding ply. No woven fabric can be visible or exposed on one surface of the bonding ply, i.e. the corresponding side of the woven fabric can be completely covered with the material of the bonding ply, while the woven fabric is at least partially visible or exposed on the opposite surface of the bonding ply, i.e. the open spaces in the woven fabric are substantially filled with the material of the bonding ply. Alternatively, the woven fabric can also be at least partially visible or exposed on both surfaces of the bonding ply. Preferably, between about 50% and about 99% of the outer surface of the bidirectional woven fabric, more preferably between about 60% and about 90%, particularly preferably between about 70% and about 80%, is embedded in the at least one bonding ply. Preferably, the at least one bidirectional woven fabric is completely embedded in the at least one bonding ply. In this embodiment, the bonding ply is present on both sides of the at least one bidirectional woven fabric and covers it completely. Preferably, the bonding ply is arranged on both outer sides of the woven fabric and embeds the woven fabric therein. Further preferably, the woven fabric is embedded asymmetrically in the bonding ply, the thickness of which is greater on one outer side of the woven fabric than on the opposite side.

The anti-corrosion tape according to the invention is preferably wound with tension. As already described above, creases, in particular in the overlap area, and empty spaces in the overlap area are reduced or even avoided by the anti-corrosion tape. This is possible thanks to the bidirectional woven fabric. The at least one woven fabric is supple in the transverse direction and stiffer in the longitudinal direction. The anti-corrosion tape according to the invention also improves the bond in the overlap area of the winding between the upper surface or the upper side of the anti-corrosion tape of the previous winding and the lower surface or the lower side of the anti-corrosion tape of the subsequent winding. By reducing or eliminating the cavities at the overlap stage, the surface of the pipe is also better wetted or covered.

The present invention further relates to a method for producing an anti-corrosion tape as described above, wherein at least one woven fabric is joined together with at least one bonding ply, whereby the at least one bidirectional woven fabric has a ratio of a bending stiffness according to the beam method according to DIN 53121:2014-08 in the transverse direction to the longitudinal direction in a range between 1:1.1 and about 1:8. Preferably, the at least one woven fabric is joined to the at least one bonding ply by a calender, preferably under pressure. Preferably, in the method according to the invention, the at least one woven fabric is at least partially, more preferably completely, embedded in the at least one bonding ply. Preferably, the bonding ply is brought together in the calender with the band-like bidirectional woven fabric on a first outer side thereof and the material of the bonding ply is pressed by the calender through the recesses or free spaces in the woven fabric band, so that these are filled and the woven fabric is thus embedded in the bonding ply. Preferably, the material of the bonding ply is pressed beyond the free spaces in the woven fabric onto a second outer side of the woven fabric opposite the first outer side and forms a sufficiently adhesive layer there to form a direct bond with the object to be protected against corrosion or, if necessary, to be bonded to a carrier layer.

Preferably, the material of the at least one bonding ply is produced by means of an internal mixer and rolled out in the calendering process, in which it is joined to the at least one woven fabric. Preferably, the at least one bonding ply has a temperature in a range from about 60° C. to about 170° C. during the mixing process, more preferably in a range from about 80°° C. to about 120° C., particularly preferably in a range from about 90° C. to about 110° C.

The present invention also relates to the use of an anti-corrosion tape for protecting pipes and systems comprising pipes, tanks and constituent parts of tanks. A pipe or a tubular body is a long cylindrical hollow body that is primarily used to transport gases, liquids, but also solid bodies. A pipe can be, for example, a water pipe, a district heating pipe or a component of a pipeline. Constituent parts of tanks include tank bottoms, metal containers, fittings and tank connections such as inlets and outlets. The anti-corrosion tape can be used individually or in combination with another anti-corrosion tape.

The present invention also relates to a method for achieving corrosion protection on pipes and systems comprising pipes, tanks and constituent parts of tanks with an at least two-layer anti-corrosion tape, wherein the pipe is wrapped with the anti-corrosion tape in an overlapping manner in such a way that a continuous coating can be formed. Preferably, the anti-corrosion tape is wrapped with tension. Preferably, the anti-corrosion tape is wound with a tensile force in a range between about 2 N/cm to about 50 N/cm, more preferably between about 5 N/cm to about 40 N/cm, particularly preferably between about 10 N/cm to about 30 N/cm. This high tension also leads to high pressure forces of the anti-corrosion tape on the surface of the object to be wrapped. This in turn favours the adhesion of the bonding ply of the upper layer of the anti-corrosion tape to the bonding ply of the lower layer of the anti-corrosion tape in the overlap area, so that together they can form a continuous layer in which the woven fabric is completely embedded.

The present invention also relates to a pipe, tank or constituent part of a tank with an anti- corrosion tape according to the invention, wherein further preferably the pipe, the tubular object, the pipeline, the pipes of the system comprising pipes, the tank or the constituent part of a tank as well as other systems and installations are wrapped with the anti-corrosion tape, preferably overlapping, further preferably spirally, or the anti-corrosion tape according to the invention is applied to a surface of the said components.

Finally, the present invention relates to the use of a bidirectional woven fabric as defined above in an anti-corrosion tape as described above, preferably embedded in at least one bonding ply, preferably in exactly one bonding ply.

An exemplary anti-corrosion tape, in particular for producing a pipe covering such as pipelines, comprises at least one bonding ply made of a material comprising at least one butyl rubber and/or at least one polyisobutylene, wherein at least one bidirectional woven fabric is at least partially embedded in the at least one bonding ply, wherein the at least one bidirectional woven fabric comprises at least one weft yarn, and wherein the at least one weft yarn comprises a material selected from a group comprising polypropylene, polyethylene, polyamides, aramid fibres, polyester, natural fibres or a combination of at least two of said materials.

A further exemplary anti-corrosion tape, in particular for producing a pipe covering or pipelines, comprises at least one bonding ply made of a material comprising at least one butyl rubber and/or at least one polyisobutylene, wherein at least one bidirectional woven fabric is at least partially embedded in the at least one bonding ply, wherein the at least one bidirectional woven fabric comprises at least one warp yarn and wherein the at least one warp yarn comprises a material selected from a group comprising polypropylene, polyethylene, polyamides, aramid fibres, polyester, natural fibres or a combination of at least two of said materials.

A further exemplary anti-corrosion tape, in particular for producing a pipe covering or pipelines, comprises at least one bonding ply made of a material comprising at least one butyl rubber and/or at least one polyisobutylene, wherein at least one bidirectional woven fabric is at least partially embedded in the at least one bonding ply, wherein the at least one bidirectional woven fabric comprises at least one warp yarn and at least one weft yarn, and wherein the at least one warp yarn and the at least one weft yarn comprise a material selected from a group comprising polypropylene, polyethylene, polyamides, aramid fibres, polyester, natural fibres or a combination of at least two of said materials.

A further exemplary anti-corrosion tape, in particular for producing a pipe covering or pipelines, comprises at least one bonding ply produced from a material comprising at least one butyl rubber and/or at least one polyisobutylene, wherein at least one bidirectional woven fabric is at least partially embedded in the at least one bonding ply, wherein the at least one bidirectional woven fabric comprises at least one warp yarn and at least one weft yarn, wherein the at least one woven fabric has a tensile strength in a transverse direction according to DIN EN ISO 13934-1 in a range between about 200 N/5 cm and about 2500 N/5 cm, and wherein the at least one warp yarn has a tensile strength according to DIN EN ISO 13934-1 in a range between about 400 N/5 cm and about 4000 N/5 cm.

A further exemplary anti-corrosion tape, in particular for producing a pipe covering or pipelines, comprises at least one bonding ply produced from a material comprising at least one butyl rubber and/or at least one polyisobutylene, wherein at least one bidirectional woven fabric is at least partially embedded in the at least one bonding ply, wherein the at least one bidirectional woven fabric comprises at least one warp yarn and at least one weft yarn, wherein the at least one woven fabric has an elongation according to DIN EN ISO 13934-1 in a range between about 2% and about 100% in the transverse direction and in the longitudinal direction, preferably in a range between about 10% and about 24% in the transverse direction and in a range between about 28% and about 60% in the longitudinal direction.

A further exemplary anti-corrosion tape, in particular for producing a pipe covering or pipelines, comprises at least one bonding ply produced from a material comprising at least one butyl rubber and/or at least one polyisobutylene, wherein at least one bidirectional woven fabric is at least partially embedded in the at least one bonding ply, wherein the at least one bidirectional woven fabric has a tensile strength ratio in the transverse direction to the longitudinal direction in a range between about 2:1 and about 1:20.

A further exemplary anti-corrosion tape, in particular for producing a pipe covering or pipelines, comprises at least one bonding ply produced from a material comprising at least one butyl rubber and/or at least one polyisobutylene, wherein at least one bidirectional woven fabric is at least partially, preferably completely, embedded in the at least one bonding ply, wherein the at least one bidirectional woven fabric has a ratio of an average bending stiffness according to the beam method according to DIN 53121:2014-08 in the transverse direction to the longitudinal direction in a range between approximately 1:1.3 to 1:8. Preferably, the weft yarn is formed from tapes, more preferably fibrillated tapes, and the warp yarn from monofilaments. Further preferably, the weft yarn is made of polypropylene and the warp yarn made of polyethylene or polyesters, in particular polyethylene terephthalate. Further preferably, the bidirectional woven fabric has 60 to 110 weft yarns per 10 cm and 145 to 190 warp yarns per 10 cm.

A further exemplary anti-corrosion tape, in particular for producing a pipe covering or pipelines, comprises at least one bonding ply made of a material comprising at least one butyl rubber and/or at least one polyisobutylene, wherein at least one bidirectional woven fabric is completely embedded in the at least one bonding ply, wherein the at least one bidirectional woven fabric comprises at least one warp yarn and at least one weft yarn, and wherein the at least one warp yarn and the at least one weft yarn comprise a material selected from a group comprising polypropylene, polyethylene, polyamides, aramid fibres, polyester, natural fibres or a combination of at least two of said materials.

A further exemplary anti-corrosion tape, in particular for producing a pipe covering or pipelines, comprises at least one bonding ply made of a material comprising at least one butyl rubber and/or at least one polyisobutylene, wherein at least one bidirectional woven fabric is completely embedded in the at least one bonding ply, wherein the at least one bidirectional woven fabric has a tensile strength ratio in the transverse direction to the longitudinal direction in a range between about 2:1 and about 1:20.

A further exemplary anti-corrosion tape, in particular for producing a pipe covering or pipelines, comprises at least one bonding ply made of a material comprising at least one butyl rubber and/or at least one polyisobutylene, wherein at least one bidirectional woven fabric is completely embedded in the at least one bonding ply, wherein the at least one bidirectional woven fabric has a ratio of an average bending stiffness according to the beam method according to DIN 53121:2014-08 in the transverse direction to the longitudinal direction in a range between approximately 1:1.3 to 1:8.

The above preferred embodiments of the invention are non-limiting but nevertheless preferred examples. It is also possible to combine the aforementioned areas and components of each embodiment with one or more other embodiments.

The present invention is explained in more detail with reference to the following practical examples.

A first anti-corrosion tape was produced. A bonding ply comprised about 40% by weight, based on the total amount of the bonding ply, of a third butyl rubber having a Mooney viscosity ML (1+8) at 125° C. in a range of about 46 MU to about 56 MU and an unsaturation in a range of about 1.4 mol % to about 1.8 mol %. The bonding ply comprised various additives. The additives comprised about 60% by weight, based on the total amount of the bonding ply. A woven fabric to be at least partially embedded in the bonding ply comprised weft yarns of polypropylene and warp yarns of polyethylene. The embedding was carried out over about 70% of the surface of the woven fabric, so about 30% of the woven fabric was exposed and therefore visible. The weft yarn was ribbon-like. A monofilament was used as the warp yarn. The woven fabric had a tensile strength according to DIN EN ISO 13934-1 of over 900 N/5 cm in the transverse direction and over 1400 N/5 cm in the longitudinal direction. The ratio between the tensile strengths in the transverse direction and the longitudinal direction was 1:1.55. The woven fabric exhibited an elongation of over 15% in the transverse direction and in the longitudinal direction in accordance with DIN EN ISO 13934-1. The elongation ratio of the weft yarn to warp yarn was 1:1. The weft yarn had a thread count of 64 per 10 cm. The warp yarn had a thread count of 156 per 10 cm. The yarn count ratio in the transverse direction to the longitudinal direction was 1:2.4. The bidirectional woven fabric had an average bending stiffness according to the beam method in accordance with DIN 53121:2014-08 of around 0.398 N*mm in the transverse direction and around 0.770 N*mm in the longitudinal direction. The bidirectional woven fabric had a ratio of an average bending stiffness according to the beam method in accordance with DIN 53121:2014-08 in the transverse direction to the longitudinal direction of approximately 1:1.93. The woven fabric was joined to the bonding ply in a calender. The anti-corrosion tape was wound on pipes with an overlap of around 50% of the width of the anti-corrosion tape and with tension, in particular a tensile force of at least around 20 N/cm Since tension is applied when winding the tape onto a pipe, few or no creases were formed and an improved bond was achieved in the overlap area.

A second anti-corrosion tape was produced. The bonding ply was made from the same material as in the case of the first anti-corrosion tape and was also produced in a calender, albeit at a higher pressure. The woven fabric used was one with 100 weft threads per 10 cm in the form of polypropylene tapes and 156 warp threads per 10 cm in the form of polyethylene monofilaments. The stretch ratio of the weft yarn to warp yarn was 1.4:1. The woven fabric was completely embedded in the bonding ply. The bidirectional woven fabric had an average bending stiffness according to the beam method in accordance with DIN 53121:2014-08 of around 0.45 N*mm in the transverse direction and around 1.4 N*mm in 5 the longitudinal direction. The bidirectional woven fabric had a ratio of an average bending stiffness according to the beam method in accordance with DIN 53121:2014-08 in the transverse direction to the longitudinal direction of around 1:3.11. When wound on a pipe in accordance with the first anti-corrosion tape, the empty or hollow spaces in the overlap area could be reduced even further compared to the first anti-corrosion tape.

1. An anti-corrosion tape, in particular for producing a pipe covering, comprising at least one bonding ply, produced from a material comprising at least one butyl rubber and/or at least one polyisobutylene, wherein at least one bidirectional woven fabric is at least partially embedded in the at least one bonding ply, whereby the at least one bidirectional woven fabric has a ratio of a bending stiffness according to the beam method according to DIN 53121:2014-08 in the transverse direction to the longitudinal direction in a range between 1:1.1 and about 1:8.

2. The anti-corrosion tape according to claim 1, wherein the at least one bidirectional woven fabric is fully embedded in the at least one bonding ply.

3. The anti-corrosion tape according to claim 1, wherein the at least one bidirectional woven fabric comprises at least one weft yarn and at least one warp yarn, and in that the at least one weft yarn and/or the at least one warp yarn comprise a material selected from a group comprising polypropylene, polyethylene, polyamides. aramid fibres, polyester, natural fibres or a combination of at least two of said materials.

4. The anti-corrosion tape according to claim 1, wherein the at least one woven fabric has an elongation according to DIN EN ISO 13934-1 in a range between about 2% and about 100% in the transverse direction and in the longitudinal direction of the at least one bidirectional woven fabric.

5. The anti-corrosion tape according to claim 1, wherein the at least one bidirectional woven fabric has a tensile strength according to DIN EN ISO 13934-1 in a range between about 200 N/5 cm and about 2500 N/5 cm in the transverse direction of the at least one bidirectional woven fabric.

6. The anti-corrosion tape according to claim 1, wherein the at least one bidirectional woven fabric has a tensile strength according to DIN EN ISO 13934-1 in a range between about 400 N/5 cm and about 4000 N/5 cm in the longitudinal direction of the at least one bidirectional woven fabric.

7. The anti-corrosion tape according to claim 1, wherein the at least one bidirectional woven fabric has a tensile strength ratio in the transverse direction to the longitudinal direction in a range between about 2:1 and about 1:20.

8. The anti-corrosion tape according to claim 1, wherein the at least one bidirectional woven fabric has a bending stiffness according to the beam method according to DIN 53121:2014-08 in a longitudinal direction of the at least one bidirectional woven fabric in a range between about 0.2 N*mm and about 1.5 N*mm.

9. The anti-corrosion tape according to claim 1, wherein the at least one bidirectional woven fabric has a bending stiffness according to the beam method according to DIN 53121:2014-08 in a transverse direction of the at least one bidirectional woven fabric in a range between about 0.1 N*mm and about 0.8 N*mm.

10. (canceled)

11. The anti-corrosion tape according to claim 1, wherein the at least one bidirectional woven fabric has a thickness in a range between about 0.2 mm and about 2 mm.

12. A method for producing an anti-corrosion tape according to claim 1, wherein at least one woven fabric is joined together with at least one bonding ply, whereby the at least one bidirectional woven fabric has a ratio of a bending stiffness according to the beam method according to DIN 53121:2014-08 in the transverse direction to the longitudinal direction in a range between 1:1.1 and about 1:8.

13. A use of an anti-corrosion tape according to claim 1 configured for protecting pipes and systems comprising pipes, tanks and constituent parts of tanks.

14. A method 16 according to claim 1 configured for achieving corrosion protection on pipes and systems comprising pipes, tanks and constituent parts of tanks with an at least two-layer anti-corrosion.

15. A pipe, tank or constituent part of a tank with the anti-corrosion tape according to claim 1.

16. A use of the bidirectional woven fabric according to claim.
